(19) United States
(12) Patent Application Publication
(10) Pub. No.: US 2019/0295751 A1
(43) Pub. Date: Sep. 26, 2019

(54) PERMANENT MAGNET, ROTARY ELECTRIC MACHINE, AND VEHICLE

(71) Applicant: KABUSHIKI KAISHA TOSHIBA, Tokyo (JP)

(72) Inventors: Masaya Hagiwara, Yokohama Kanagawa (JP); Shinya Sakurada, Shinagawa Tokyo (JP); Keiko Okamoto, Kawasaki Kanagawa (JP)

(21) Appl. No.: 16/114,657

(22) Filed: Aug. 28, 2018

(30) Foreign Application Priority Data
Mar. 22, 2018 (JP) 2018-054094

(51) Int. Cl. H01F 1/057; H02K 1/02; H02K 7/00; H02K 7/18; C22C 38/00

(52) U.S. Cl. CPC H01F 1/0577; H02K 1/02; H02K 7/003; C22C 2202/02; C22C 38/005; C22C 38/002; H02K 7/1823

(57) ABSTRACT

A permanent magnet comprises a plurality of crystal grains having a main phase of an R-Fe-B magnetic phase, R being at least one element selected from the group consisting of Nd, Pr, Dy, Tb, and Ho. A grain size distribution of the crystal grains satisfies a formula: d10<Rc<d90, the Rc indicating a single-domain critical grain size of the magnetic phase, the d10 indicating a grain size in which a cumulative frequency ratio in the grain size distribution is 10%, and the d90 indicating a grain size in which a cumulative frequency ratio in the grain size distribution is 90%.

### CROSS REFERENCE TO RELATED APPLICATION

This application is based upon and claims the benefit of priority from Japanese Patent Application No. 2018-054094, filed on Mar. 22, 2018; the entire contents of which are incorporated herein by reference.

### FIELD

Embodiments described herein relate generally to a permanent magnet, a rotary electric machine, and a vehicle.

### BACKGROUND

In automobiles, railway vehicles, and the like, it is known that a rotary electric machine such as a motor or a generator including a Nd-Fe-B-based sintered magnet is used in order to enhance efficiency. The Nd-Fe-B-based sintered magnet has a high magnetic flux density. Therefore, use of the Nd-Fe-B-based sintered magnet for the rotary electric machine makes it possible to obtain higher torque.

In the above-described motor for automobile and railway vehicle, variable speed driving ranging from low-speed rotation to high-speed rotation is performed. At this time, in a motor including a conventional Nd-Fe-B-based sintered magnet, high torque is obtained on a low-speed rotation side, but an output decreases due to generation of an induced voltage (back electromotive force) on a high-speed rotation side.

In a permanent magnet such as the Nd-Fe-B-based sintered magnet, an interlinkage magnetic flux always occurs with constant strength. At this time, the induced voltage caused by a permanent magnet increases in proportion to rotation speed. This results in that a voltage of the motor reaches an upper limit of power supply voltage and an electric current necessary for the output does not flow in the high-speed rotation. As a result, the output decreases drastically, and furthermore driving becomes impossible in a range of the high-speed rotation.

As a method of suppressing an effect of the induced voltage in the high-speed rotation, for example, a field weakening control method is cited. The field weakening control method is a method in which the magnetic flux density is decreased by generating an opposing magnetic field, thereby decreasing the number of interlinkage magnetic fluxes. However, a need of an electric current for generating the opposing magnetic field decreases motor efficiency at a time of the high-speed rotation. Furthermore, the permanent magnet having a high magnetic flux density such as the Nd-Fe-B-based sintered magnet cannot decrease the magnetic flux density sufficiently at a time of the high-speed rotation.

### BRIEF DESCRIPTION OF THE DRAWINGS

FIG. 1 is a cross-sectional schematic view illustrating a structure example of a metal structure of a permanent magnet.

FIG. 2 is a chart illustrating one example of a B-H curve of a Sm-Co based sintered magnet.

FIG. 3 is a chart illustrating one example of a B-H curve of a neodymium sintered magnet.

FIG. 4 is a chart illustrating an example of M-H curves of permanent magnets.

FIG. 5 is a chart illustrating an example of grain size distributions in the permanent magnets.

FIG. 6 is a chart illustrating a relationship between a cumulative frequency ratio and a grain size in each of the grain size distributions in the permanent magnets.

FIG. 7 is a view illustrating an example of a permanent magnet motor.

FIG. 8 is a view illustrating an example of a variable magnetic flux motor.

FIG. 9 is a view illustrating an example of a generator.

FIG. 10 is a schematic view illustrating a configuration example of a railway vehicle.

FIG. 11 is a schematic view illustrating a configuration example of an automobile.

### DETAILED DESCRIPTION

A permanent magnet of an embodiment comprises a plurality of crystal grains having a main phase of an R-Fe-B magnetic phase, R being at least one element selected from the group consisting of Nd, Pr, Dy, Tb, and Ho. A grain size distribution of the crystal grains satisfies a formula: d10<Rc<d90, the Rc indicating a single-domain critical grain size of the magnetic phase, the d10 indicating a grain size in which a cumulative frequency ratio in the grain size distribution is 10%, and the d90 indicating a grain size in which a cumulative frequency ratio in the grain size distribution is 90%.

Hereinafter, embodiments will be explained with reference to the drawings. Note that the drawings are schematic, and for example, a relation between a thickness and a plane dimension, a ratio of thicknesses of the respective layers, and the like are sometimes different from actual ones. Moreover, in the embodiments, substantially the same components are denoted by the same reference signs, and explanations thereof are omitted.

### First Embodiment

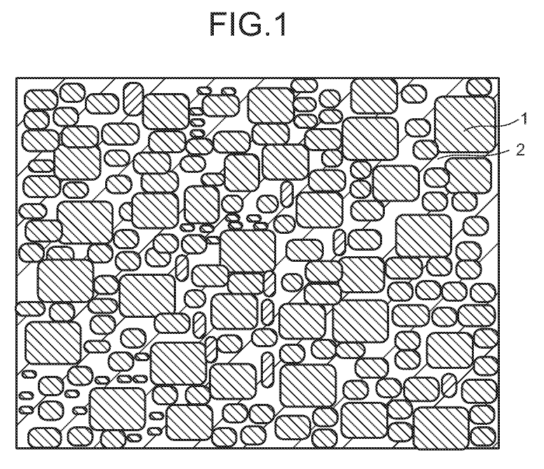

FIG. 1 is a cross-sectional schematic view illustrating a structure example of a metal structure of a permanent magnet of an embodiment. As illustrated in FIG. 1, the permanent magnet of the embodiment has a plurality of crystal grains 1 and grain boundary phases 2 provided among the crystal grains 1.

In the crystal grains 1, an R-Fe-B magnetic phase (R is at least one element selected from the group consisting of Nd, Pr, Dy, Tb, and Ho) is a main phase. The main phase is a phase having the highest volume occupancy ratio of crystal phases and amorphous phases in a magnet.

50 atomic percent or more of an R element is preferably Nd. This allows an increase in coercive force of a magnet. When the R element contains Nd, the R-Fe-B magnetic phase may have, for example, a Nd₂Fe₁₄B crystal phase.

An R concentration of the grain boundary phase 2 is preferably higher than an R concentration of the R-Fe-B magnetic phase. For example, when a Nd concentration of the grain boundary phase 2 is higher than a Nd concentration of the R-Fe-B magnetic phase, the grain boundary phases 2 are also referred to as Nd-rich phases.

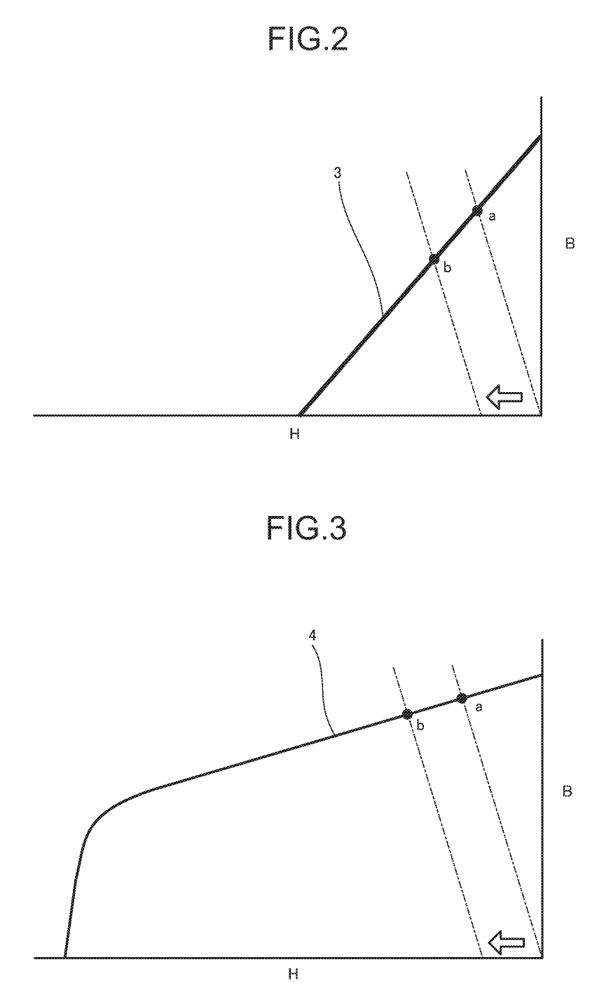

Here, a difference between a conventional neodymium sintered magnet and a Sm-Co-based sintered magnet will be explained with reference to FIG. 2 and FIG. 3. A curve 3 illustrated in FIG. 2 is one example of a B-H curve of the Sm-Co-based sintered magnet, and a curve 4 illustrated in FIG. 3 is one example of a B-H curve of the neodymium sintered magnet. As illustrated in FIG. 2 and FIG. 3, in a case of the conventional neodymium sintered magnet, a magnetization decreased range in a change from an operating point a to an operating point b is smaller than that of the Sm-Co-based sintered magnet. It is found from this that the Sm-Co-based sintered magnet allows a large reduction in magnetization in a case of applying the same opposing magnetic field and this allows a magnetic flux density to be decreased by a small opposing magnetic field, namely, at a small field weakening current.

The Sm-Co-based sintered magnet can achieve a high recoil magnetic permeability by forming a distribution of coercive force in a sintered body. This has a close relation to coercive force mechanisms of sintered magnets such as a pinning type and a nucleation type. The Sm-Co-based sintered magnet having the pinning-type coercive force mechanism can make an area through which a magnetic domain wall easily passes (an area having a low coercive force) and an area through which a magnetic domain wall does not easily pass (an area having a high coercive force) coexist with each other because magnetic domain wall propagation is prevented by a pinning site. On the other hand, in the neodymium sintered magnet generally called the nucleation type, when some extent of external magnetic fields is applied, a magnetization-reversal nucleus (nucleation site) occurs, and an inverse domain expands with the occurrence point being a starting point, and therefore, it is difficult to achieve a high recoil magnetic permeability.

In the Sm-Co-based sintered magnet, Co (partly substituted Fe) is mainly responsible for magnetization, while in the neodymium sintered magnet, Fe is responsible for the magnetization. Because between Fe and Co, Fe has a higher magnetic moment, the neodymium sintered magnet containing more Fe more easily obtains a high saturation magnetization as the permanent magnet, and therefore, it also easily obtains a high value in a residual magnetization of the permanent magnet. When a rotary electric machine which performs variable speed driving ranging from low-speed rotation to high-speed rotation is considered, due to no need of high torque at a time of high-speed rotation, the magnetization is preferably low from the viewpoint of induced voltage suppression. On the other hand, due to a need to generate high torque at a time of low-speed rotation, the magnetization is preferably high. Further, obtaining the high torque at the time of low-speed rotation also means a possibility of downsizing the rotary electric machine. In addition, a less content of heavy rare earth such as Dy or Tb also makes a neodymium magnet advantageous in an aspect of a material cost.

The permanent magnet of the embodiment is the R-Fe-B permanent magnet as described above, and has a high recoil magnetic permeability, a high coercive force, and a high residual magnetization. In the permanent magnet of the embodiment, a residual magnetization is preferably, for example, 1.16 T or more, and a coercive force Hcj on a M-H curve is preferably 1000 kA/m or more, and a recoil magnetic permeability is preferably 1.15 or more. The residual magnetization is more preferably 1.2 T or more. The coercive force Hcj is more preferably 1200 kA/m or more. The recoil magnetic permeability is more preferably 1.2 or more.

The recoil magnetic permeability is defined as follows. A magnet is magnetized by a magnetizing apparatus and a pulsed magnetic field. Magnetization measurement is performed with respect to this magnet to obtain a B-H curve. A linear fit is performed with respect to this B-H curve, thereby finding a slope. A value obtained by dividing this slope by a vacuum permeability 1.26×10⁻⁶ is found as the recoil magnetic permeability. In the magnetization measurement, a minor loop is measured in an external magnetic field corresponding to operating points to be used in the rotary electric machine.

In the permanent magnet of the embodiment having the above-described magnetic properties, when a single-domain critical grain size of the R-Fe-B magnetic phase is set as Rc, a grain size in which a cumulative frequency ratio in a grain size distribution of the crystal grains is 10% is set as d10, and a grain size in which a cumulative frequency ratio is 90% is set as d90, the grain size distribution satisfies d10<Rc<d90. In other words, d10 is smaller than Rc, and d90 is larger than Rc.

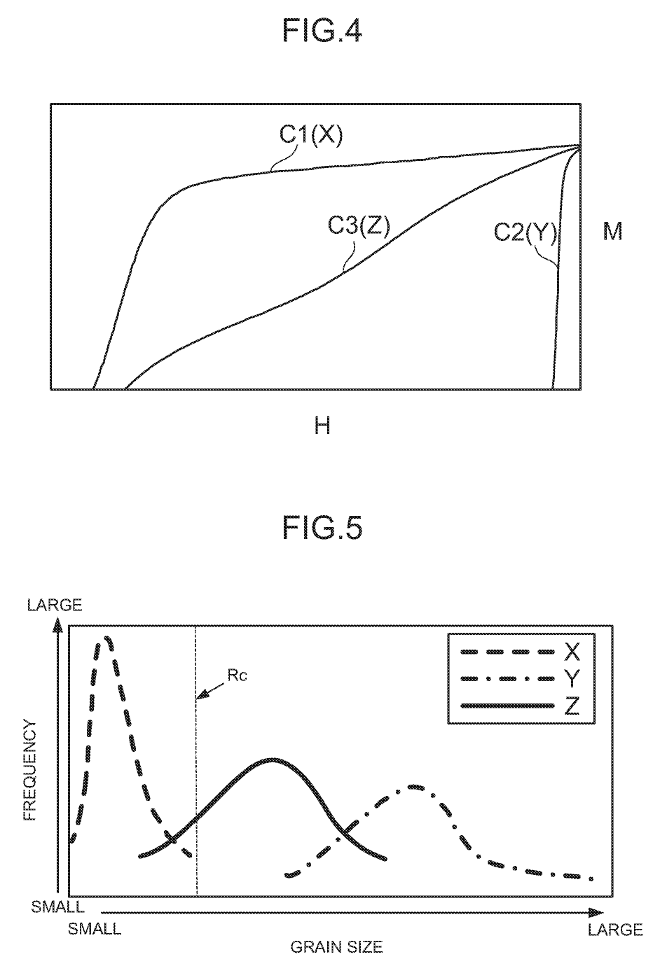

Here, a relationship between the grain size distribution and the magnetic properties of each of permanent magnets will be explained. FIG. 4 is a chart illustrating an example of M-H curves of permanent magnets. FIG. 4 illustrates a M-H curve C1 of a permanent magnet X, a M-H curve C2 of a permanent magnet Y, and a M-H curve C3 of a permanent magnet Z. The M-H curve C1 indicates that the coercive force and the residual magnetization are high but the recoil magnetic permeability is low in the permanent magnet X. The M-H curve C2 indicates that the recoil magnetic permeability and the residual magnetization are high but the coercive force is low in the permanent magnet Y. In contrast to the above, the M-H curve C3 indicates that any of the recoil magnetic permeability, the residual magnetization, and the coercive force is high in the permanent magnet Z.

When the respective metal structures of the permanent magnet X to the permanent magnet Z are observed, it is found that the respective grain size distributions of crystal grains of the permanent magnet X to the permanent magnet Z are different from each other. FIG. 5 is a chart illustrating an example of the respective grain size distributions of the permanent magnet X to the permanent magnet Z. As illustrated in FIG. 5, the permanent magnet X has the grain size distribution in which a frequency (the number) of relatively small crystal grains is the largest. The permanent magnet Y has the grain size distribution in which a frequency of relatively large crystal grains is the largest. The permanent magnet Z has the grain size distribution in which a frequency of crystal grains which are larger than main crystal grains of the permanent magnet X and smaller than main crystal grains of the permanent magnet Y is the larger.

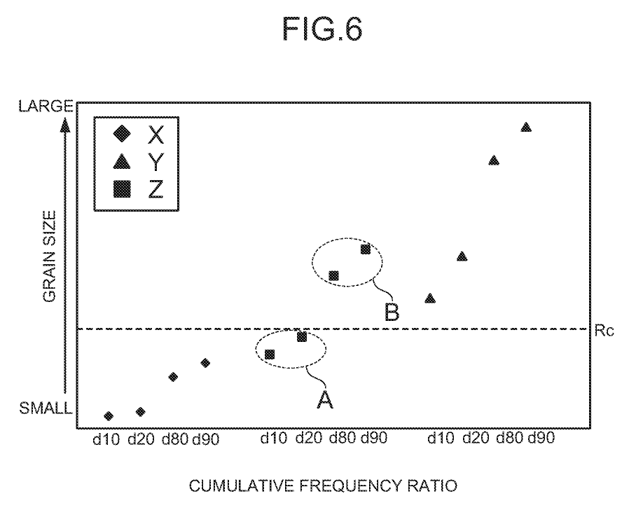

Furthermore, as illustrated in FIG. 5, the grain size distributions of the permanent magnet X and the permanent magnet Y do not overlap the single-domain critical grain size Rc. In contrast to this, the grain size distribution of the permanent magnet Z overlaps the single-domain critical grain size Rc. Furthermore, FIG. 6 illustrates a relationship between a cumulative frequency ratio and a grain size in each of the grain size distributions in the permanent magnet X to the permanent magnet Z. In FIG. 6, d10 indicates the grain size in which the cumulative frequency ratio in the grain size distribution of the crystal grains is 10%, d20 indicates the grain size in which the cumulative frequency ratio in the grain size distribution of the crystal grains is 20%, d80 indicates the grain size in which the cumulative frequency ratio in the grain size distribution of the crystal grains is 80%, and d90 indicates the grain size in which the cumulative frequency ratio in the grain size distribution of the crystal grains is 90%.

It is found from FIG. 5 and FIG. 6 that the grain size distribution of the crystal grains satisfies d10<Rc<d90, thereby making it possible to achieve a high recoil magnetic permeability in addition to high magnetization and a high coercive force. As described above, the neodymium-based sintered magnet has the nucleation-type coercive force mechanism, and the occurrence of the magnetization-reversal nucleus causes propagation of the inverse domain in the crystal grains and to the adjacent crystal grains, resulting in demagnetization. In the typical neodymium-based sintered magnet in which such demagnetization behavior occurs, a crystal grain size of a main phase is about several tens of μm. In contrast to this, Rc is several tens to several hundreds of nm and has a quite different scale. The crystal grain whose crystal grain size is less than Rc becomes more stable in an aspect of energy in reversing the moment of the whole grain than in generating the inverse domain inside. On the other hand, in the crystal grain whose grain size is equal to or more than Rc, the occurrence of the magnetization-reversal nucleus and the propagation of the inverse domain become stable in the aspect of energy. That is, as illustrated in FIG. 6, as long as by distributing the crystal grains less than Rc (crystal grains A) and the crystal grains equal to or more than Rc (crystal grains B) in the permanent magnet, timings of the moment reversal of the crystal grains A and the occurrence of the magnetization-reversal nucleus in the crystal grains B are made different from each other, achievement of a coercive force distribution on a micro scale in a magnetic body becomes possible. This makes it possible to increase the recoil magnetic permeability while achieving the high coercive force and residual magnetization.

In the permanent magnet of the embodiment, the crystal grain size of the R-Fe-B magnetic phase satisfies d10<Rc<d90 as described above. When Rc is d10 or less, the crystal grains exhibit nucleation-type coercive force behavior similarly to the normal neodymium sintered magnet, and the recoil magnetic permeability is decreased. In some cases, it is not possible to obtain a sufficient coercive force. When d90 is equal to or more than Rc, each of the crystal grains does not easily undergo magnetization reversal, and therefore, a large coercive force is easy to obtain but a distribution of the coercive force is difficult to obtain, resulting in a decrease in the recoil magnetic permeability.

In a case where a distribution width of the crystal grain sizes is too wide or too narrow (a case where the crystal grains are too coarse or too uniform), the coercive force distribution on a micro scale is difficult to form, and therefore, the recoil magnetic permeability is easy to decrease. Consequently, the permanent magnet of the embodiment preferably satisfies Rc/50<d10<Rc, Rc<d90<10Rc, further preferably satisfies Rc/10<d10<Rc/1.2, 1.2Rc<d90<5Rc, further preferably satisfies Rc/5<d10<Rc/1.3, 1.3Rc<d90<3Rc, and further preferably satisfies Rc/2<d10<Rc/1.4, 1.4Rc<d90<2Rc.

As described above, the permanent magnet of the embodiment includes a plurality of crystal grains represented by a predetermined grain size distribution and achieves the high recoil magnetic permeability in addition to the high magnetization and the high coercive force. Therefore, it is possible to suppress a decrease in output in the rotary electric machine which performs the variable speed driving ranging from low speed to high speed. In addition, it is possible to reduce an electric current for generating an opposing magnetic field when a field weakening control method is used.

Next, an example of a method of manufacturing the permanent magnet of the embodiment will be explained. The permanent magnet of the embodiment is manufactured by a method of including, for example, a process of hot-pressing an R-Fe-B quenched ribbon.

The R-Fe-B quenched ribbon is produced by subjecting a raw material alloy to high-frequency melting, and dropping it in a single roll or a twin roll. Without being limited to this, a commercially available ribbon may be used. The obtained quenched ribbon is coarsely pulverized into several hundreds of μm, filled in a metal mold, and pressed, for example, at a pressure of not less than 0.5 tons nor more than 2 tons. Thereafter, hot pressing is performed. The hot pressing is performed by heating, for example, for not shorter than 1 minute nor longer than 60 minutes at a temperature of not lower than 600° C. nor higher than 1000° C. under a pressure of not less than 0.5 tons nor more than 2 tons. Thereafter, a molded body is cooled, for example, at a cooling rate of not less than 1° C./min nor more than 20° C./min. The permanent magnet of the embodiment can be obtained by the above process.

The obtained magnet may be subjected to hot working. The hot working can be achieved by, for example, filling a larger metal mold with the magnet obtained by the hot pressing and performing heating and pressing. Alternatively, it can also be achieved by performing extruding while heating the magnet into a ring shape or a bar shape. The hot working is performed by heating, for example, for not shorter than 1 minute nor longer than 60 minutes at a temperature of not lower than 650° C. nor higher than 1000° C. at a pressure of not less than 0.5 tons nor more than 2 tons and cooling at a cooling rate of not less than 1° C./min nor more than 20° C./min Performing the hot working allows an increase in the residual magnetization of the magnet.

The obtained magnet may be subjected to heat treatment in which it is heated for not shorter than 5 minutes nor longer than 60 minutes at a temperature of not lower than 650° C. nor higher than 1000° C. and cooled at a cooling rate of not less than 1° C./min nor more than 20° C./min Performing the above-described heat treatment makes it possible to enhance controllability of a grain size distribution of crystal grains, or the like and enhance the magnetic property such as the recoil magnetic permeability. The above-described heat treatment may be performed after the hot pressing.

The hot working and the hot pressing using the quenched ribbon generally aim at an increase in coercive force by producing a magnet having a crystal grain size not more than almost the same one as Rc or improvement in heat resistance, and at restraining the grain size from becoming coarse and at uniformizing distribution. Therefore, a recoil magnetic permeability of a magnet having uniformized crystal grains is easy to decrease. In contrast to this, the method of manufacturing the permanent magnet of the embodiment makes it possible to enhance the magnetic property such as the recoil magnetic permeability by consciously forming coarse crystal grains having an appropriate grain size distribution in proper quantity.

In place of the above-described quenched ribbon, for the permanent magnet of the embodiment, for example, a fine crystal grain alloy obtained by using a hydrogenation decomposition desorption recombination (HDDR) method may be used as a raw material, or fine powder pulverized to a degree of the single-domain critical grain size Rc may be used as a raw material. The HDDR method is a method of producing fine crystal grains by subjecting a raw material to hydrogenation decomposition desorption recombination, and the raw material alloy is subjected to heat treatment for not shorter than 30 minutes nor longer than 10 hours at a temperature of not lower than 700° C. nor higher than 1000° C. in a hydrogen atmosphere (Hydrogenation and Decomposition), and thereafter is subjected to heat treatment for not shorter than 30 minutes nor longer than 10 hours at not lower than 700° C. nor higher than 1000° C. in a reduced-pressure Ar atmosphere (Desorption and Recombination). Further, as a method of producing the fine powder, a method of pulverization with a jet mill using a He gas, or the like is cited.

A composition of the permanent magnet is measured by, for example, an ICP (Inductively Coupled Plasma) emission spectrochemical analysis method, SEM-EDX (SEM-Energy Dispersive X-ray Spectroscopy), TEM-EDX (Transmission Electron Microscope-EDX), or the like. A volume ratio of each of phases is comprehensively determined by using an observation with an electron microscope or an optical microscope, X-ray diffraction, and the like in combination, and can be found by an areal analysis method for an electron micrograph in which a cross section of the permanent magnet has been photographed. In the cross section of the permanent magnet, a cross section at a substantially central portion of a surface having a maximum area in a sample is used.

The metal structure of the crystal grains 1, the grain boundary phases 2, and so on is recognized, for example, as follows. First, an observation of a sample is performed with a STEM. At this time, a position of the grain boundary phases is specified by observing the sample with a SEM, and the sample is processed by using focused ion beams (FIB) so that the grain boundary phases come into view, thereby allowing observation efficiency to be enhanced. On this occasion, the sample is preferably a non-magnetized article. Observation conditions are set to, for example, an acceleration voltage of 200 kV and a measurement area of 30 μm×30 μm.

Next, a concentration of each of elements in the sample is measured by using, for example, STEM-energy dispersive X-ray spectroscopy (STEM-EDX) utilizing the STEM.

In measuring the concentration of each of the elements by the STEM-EDX, a sample for measurement is cut out from the 1 mm or more inside of a surface of the sample. Further, a face parallel to an easy magnetization axis (c axis) is observed with an observation magnification of 100 k times. Next, mapping of each of the elements in the same field of view is performed, and each of the phases is specified, to measure the concentration of each of the elements in the phases.

The grain size distribution of the crystal grains is calculated from a STEM image. With respect to a grain identified as a crystal grain, a length in a longitudinal direction is set as a grain size. The ones in each of which the whole of the crystal grain can be confirmed in an observation range are measured, and about 100 points are measured per one magnet.

The single-domain critical grain size Rc is calculated by a formula: R_{c}=12 m₀e_{w}/Jₛ². mo is a space permeability. Jₛ is a saturation magnetization. e_{w} is a magnetic domain wall energy and calculated by a formula e_{w}=m₀√AK₁. K₁ is an anisotropy constant, and A is an exchange stiffness constant.

### Second Embodiment

The permanent magnet of the first embodiment can be used for a rotary electric machine such as various motors or a generator. In addition, it can also be used as a stationary magnet or a variable magnet of a variable magnetic flux motor. The various motors are configured by using the permanent magnet of the first embodiment. When the permanent magnet of the first embodiment is applied to the variable magnetic flux motor, the techniques disclosed in Japanese Laid-open Patent Publication No. 2008-29148 and Japanese Laid-open Patent Publication No. 2008-43172 can be applied to the configuration of the variable magnetic flux motor and a drive system, for example.

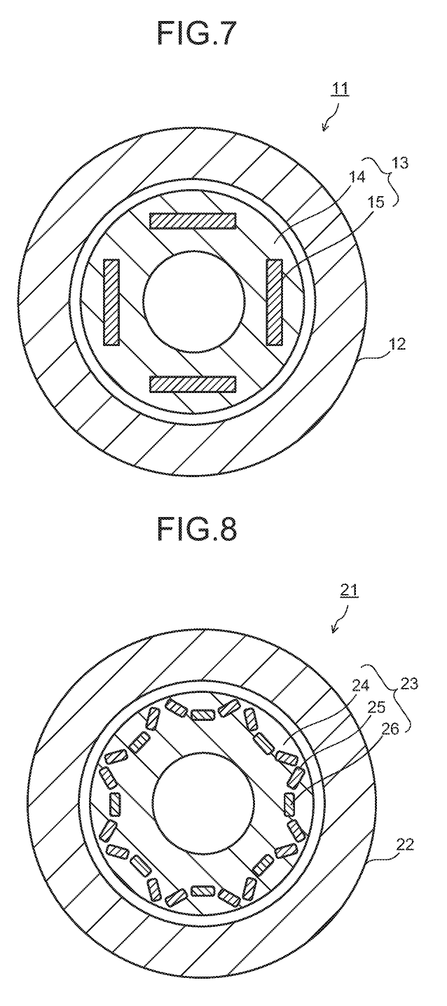

Next, a motor and a generator including the above-described permanent magnet will be explained with reference to the drawings. FIG. 7 is a view illustrating a permanent magnet motor. In a permanent magnet motor 11 illustrated in FIG. 7, a rotor 13 is disposed in a stator 12. In an iron core 14 of the rotor 13, permanent magnets 15 which are the permanent magnets of the first embodiment are disposed. A magnetic flux density (flux quantum) of the permanent magnet 15 is allowed to be variable. The permanent magnet 15 is not affected by a Q-axis current but can be magnetized by a D-axis current because a magnetization direction thereof is perpendicular to a Q-axis direction. The rotor 13 is provided with a magnetization winding (not illustrated). There is made the structure in which by passing an electric current from a magnetization circuit to this magnetization winding, its magnetic field acts directly on the permanent magnets 15.

As the permanent magnet 15, the permanent magnet of the first embodiment can be used. This makes it possible to suppress a decrease in output at a time of high-speed rotation even when variable speed driving ranging from low speed to high speed is performed.

FIG. 8 is a view illustrating a variable magnetic flux motor. In a variable magnetic flux motor 21 illustrated in FIG. 8, a rotor 23 is disposed in a stator 22. In an iron core 24 of the rotor 23, the permanent magnets of the first embodiment are disposed as stationary magnets 25 and variable magnets 26. A magnetic flux density (flux quantum) of the variable magnet 26 is allowed to be variable. The variable magnet 26 is not affected by a Q-axis current but can be magnetized by a D-axis current because a magnetization direction thereof is perpendicular to a Q-axis direction. The rotor 23 is provided with a magnetization winding (not illustrated). There is made the structure in which by passing an electric current from a magnetization circuit to this magnetization winding, its magnetic field acts directly on the variable magnets 26.

According to the permanent magnet of the first embodiment, it is possible to obtain a coercive force suitable for the stationary magnet 25. When the permanent magnet of the first embodiment is applied to the variable magnet 26, it is sufficient that, for example, the coercive force is controlled in a range of not less than 100 kA/m nor more than 500 kA/m by changing manufacturing conditions. Note that in the variable magnetic flux motor 21 illustrated in FIG. 8, the permanent magnet of the first embodiment can be used for both the stationary magnet 25 and the variable magnet 26, and the permanent magnet of the first embodiment may be used for either of the magnets. Because the variable magnetic flux motor 21 is capable of outputting large torque with a small apparatus size, it is suitable for a motor of a hybrid vehicle, an electric vehicle, or the like required to have a high-output and compact motor.

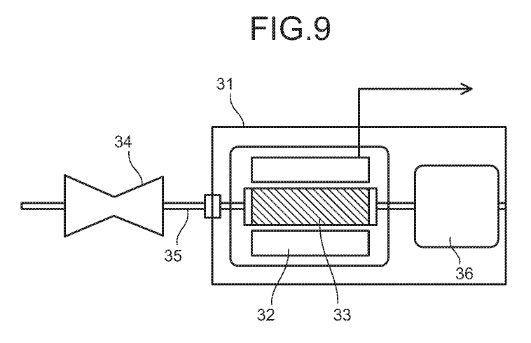

FIG. 9 illustrates a generator. A generator 31 illustrated in FIG. 9 includes a stator 32 using above-described permanent magnet. A rotor 33 disposed inside the stator 32 is connected via a shaft 35 to a turbine 34 provided at one end of the generator 31. The turbine 34 is rotated by, for example, fluid supplied from the outside. Note that in place of the turbine 34 rotated by the fluid, the shaft 35 can also be rotated by transferring dynamic rotation such as regenerated energy of an automobile. Various publicly-known configurations can be employed for the stator 32 and the rotor 33.

The shaft 35 is in contact with a commutator (not illustrated) disposed on the opposite side to the turbine 34 with respect to the rotor 33, so that an electromotive force generated by a rotation of the rotor 33 is boosted to a system voltage and is transmitted as an output from the generator 31 via an isolated bus and a main transformer (not illustrated). The generator 31 may be either of an ordinary generator and a variable magnetic flux generator. Note that the rotor 33 generates an electrostatic charge by static electricity from the turbine 34 and an axial current accompanying power generation. Therefore, the generator 31 includes a brush 36 for discharging the electrostatic charge of the rotor 33.

As described above, by applying the above-described permanent magnet to the generator, effects such as high efficiency, downsizing, and low cost are obtained.

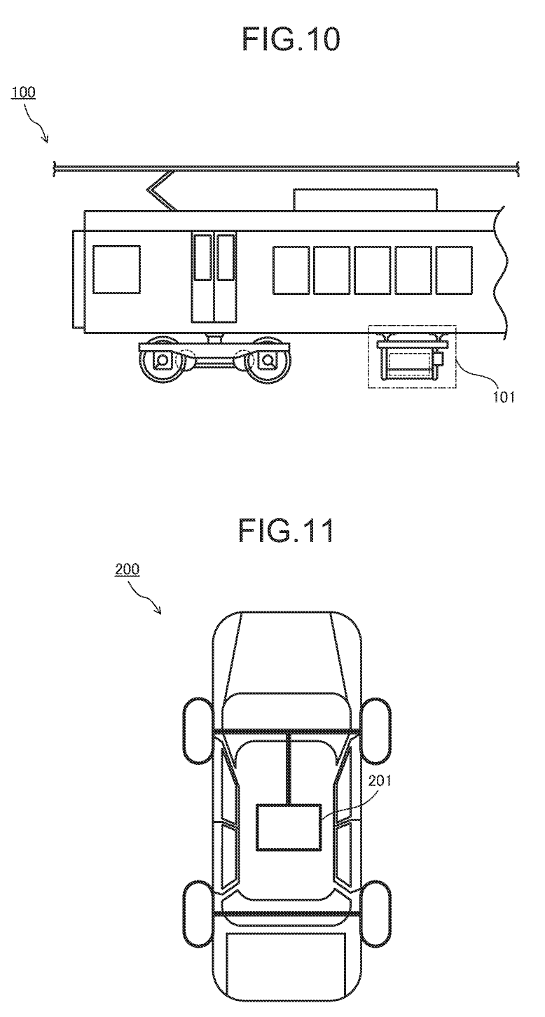

The above-described rotary electric machine may be mounted in, for example, a railway vehicle (one example of the vehicle) to be used for railway traffic. FIG. 10 is a view illustrating one example of a railway vehicle 100 including a rotary electric machine 101. As the rotary electric machine 101, any of the motors in FIGS. 7 and 8, the generator in FIG. 9, and the like described above can be used. When the above-described rotary electric machine is mounted as the rotary electric machine 101, the rotary electric machine 101 may be used as, for example, a motor which outputs driving force by using electric power supplied from an overhead wire or electric power supplied from a secondary battery mounted in the railway vehicle 100, or may be used as a generator which converts kinetic energy into electric power and supplies the electric power to various loads in the railway vehicle 100. Using such a high-efficient rotary electric machine as the rotary electric machine of the embodiment allows the railway vehicle to travel in an energy-saving manner

The above-described rotary electric machine may be mounted in an automobile (another example of the vehicle) such as a hybrid vehicle or an electric vehicle. FIG. 11 is a view illustrating one example of an automobile 200 including a rotary electric machine 201. As the rotary electric machine 201, any of the motors in FIGS. 7 and 8, the generator in FIG. 9, and the like described above can be used. When the above-described rotary electric machine is mounted as the rotary electric machine 201, the rotary electric machine 201 may be used as a motor which outputs driving force of the automobile 200 or a generator which converts kinetic energy when the automobile 200 travels into electric power. In addition, the above-described rotary electric machine may be mounted in, for example, industrial equipment (industrial motor), an air-conditioning apparatus (air conditioner and water heater compressor motor), a wind power generator, or an elevator (hoist).

### EXAMPLE

A master alloy ribbon produced by a quenching method and having a desired composition was pulverized into 150 μm or less. A ϕ 9 mm column-shaped metal mold was filled with the obtained powder. The metal mold filled with the powder was set in a hydraulic press machine placed in a controlled atmosphere heat treatment furnace, and was compressed at a pressure of 1 ton in a vacuum. Thereafter, the interior of the furnace was heated to 780° C. in a vacuum and retained for 5 minutes. After heating and retaining, by cooling to room temperature at a cooling rate of 2° C./min, a compression-molded body was obtained. The obtained molded body was put in a 10 mm column-shaped metal mold, which was set in the hydraulic press machine placed in the controlled atmosphere heat treatment furnace again, and compressed at a pressure of 1 ton in a vacuum. Thereafter, the interior of the furnace was heated to 800° C. in a vacuum and retained for 5 minutes. After heating and retaining, by introducing an Ar gas and cooling to room temperature at a cooling rate of 3° C./min, a molded body was obtained. The obtained molded body was subjected to heat treatment for 1 minute at 820° C. in an Ar atmosphere, and by gas cooling, a magnet was obtained by cooling to room temperature at a cooling rate of 10° C./min

The obtained magnet included the above-described composition and the metal structure illustrated in FIG. 1, and a grain size distribution of crystal grains satisfied d10<Rc<d90. Further, the obtained magnet had a high recoil magnetic permeability, a high residual magnetization, and a high coercive force. As described above, an R-Fe-B permanent magnet is manufactured by using hot pressing and hot working, thereby achieving a distribution of crystal grain sizes and having a high recoil magnetic permeability in addition to high magnetization and a high coercive force. Therefore, it is possible to suppress a decrease in output in a rotary electric machine which performs variable speed driving ranging from low speed to high speed. Further, it is possible to reduce an electric current for generating an opposing magnetic field when a field weakening control method is used.

While certain embodiments of the present invention have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A permanent magnet comprising
a plurality of crystal grains having a main phase of an R-Fe-B magnetic phase, R being at least one element selected from the group consisting of Nd, Pr, Dy, Tb, and Ho,
wherein a grain size distribution of the crystal grains satisfies a formula: d10<Rc<d90, the Rc indicating a single-domain critical grain size of the magnetic phase, the d10 indicating a grain size in which a cumulative frequency ratio in the grain size distribution is 10%, and the d90 indicating a grain size in which a cumulative frequency ratio in the grain size distribution is 90%.

2. The magnet according to claim 1,
wherein 50 atomic percent or more of the R element is Nd.

3. The magnet according to claim 1,
wherein the R-Fe-B magnetic phase includes a Nd₂Fe₁₄B crystal phase.

4. The magnet according to claim 1,
wherein the grain size distribution further satisfies
a formula: Rc/50<d10<Rc and
a formula: Rc<d90<10Rc.

5. The magnet according to claim 1, further comprising a grain boundary phase,
wherein a concentration of the R element of the grain boundary phase is higher than a concentration of the R element of the magnetic phase.

6. The magnet according to claim 1,
wherein a recoil magnetic permeability is 1.1 or more.

7. The magnet according to claim 1,
wherein a residual magnetization is 1.16 T or more.

8. The magnet according to claim 1,
wherein a coercive force HcJ is 1000 kA/m or more.

9. A rotary electric machine comprising:
a stator; and
a rotor,
wherein the stator or the rotor has the magnet according to claim 1.

10. The rotary electric machine according to claim 9,
wherein the rotor is connected via a shaft to a turbine.

11. A vehicle comprising the rotary electric machine according to claim 9.

12. The vehicle according to claim 11,
wherein the rotor is connected to a shaft, and
wherein rotation is transmitted to the shaft.
